(19) United States
(12) Patent Application Publication
(10) Pub. No.: US 2018/0243996 A1
(43) Pub. Date: Aug. 30, 2018

(54) Device and Method for Compressing Packaging Sleeves

(71) Applicant: SIG Technology AG, Neuhausen am Rheinfall (CH)

(72) Inventors: Klaus Baltes, Bergheim (DE); Patrick Kirchner, Aachen (DE); Sergey Anokhin, Koeln (DE)

(21) Appl. No.: 15/553,042

(22) PCT Filed: Feb. 2, 2016
(86) PCT No.: PCT/EP2016/052111

§ 371 Date: Aug. 23, 2017

(30) Foreign Application Priority Data
Feb. 27, 2015 (DE) 10 2015 102 860.3

(51) Int. Cl. B29C 65/00; B29C 65/08; B29C 65/78; B65B 51/30; B65B 65/02; B31B 50/00; B31B 50/64

(52) U.S. Cl. CPC B29C 66/43122; B29L 2031/7166; B29C 65/7841; B29C 65/787; B29C 66/1122; B29C 66/723; B29C 66/72321; B29C 66/72328; B29C 66/81457; B29C 66/8221; B29C 66/8224; B29C 66/82265; B29C 66/83221; B29C 66/83543; B29C 66/849; B65B 51/306; B65B 65/02; B31B 50/0042; B31B 50/0045; B31B 50/642; B29C 65/08

(57) ABSTRACT

A device for compressing packaging sleeves includes at least two movably supported pressure bars for compressing the packaging sleeve, and at least one drive for moving the pressure bars. The pressure bars are supported in such a way that between the pressure bars a gap is created, the longitudinal direction of which corresponds to a transport direction of the packaging sleeve. The pressure bars are supported in such a way that the distance between the pressure bars is variable. The pressure bars are supported in such a way that the pressure bars are movable in the longitudinal direction of the gap. Also described is a corresponding method for compressing packaging sleeves.

The invention relates to a device for compressing packaging sleeves, comprising: at least two movably supported pressure bars for compressing the packaging sleeves, and at least one drive for moving the pressure bars, wherein the pressure bars are supported in such a way that between the pressure bars a gap is created, the longitudinal direction of which corresponds to the transport direction of the packaging sleeve, and wherein the pressure bars are supported in such a way that the distance between the pressure bars is variable.

The invention also relates to a method for compressing packaging sleeves.

Packaging can be made in a number of ways and from the most varied of materials. A widely used manufacturing option consists of producing a blank from the packaging material, from which, through folding and further steps, initially a packaging sleeve and finally a packaging is created. One of the advantages of this type of manufacture is that the blanks are very flat and can therefore be stacked in a space-saving manner. This means that the blanks or packaging sleeves can be manufactured at a different place from where the folding and filling of the packaging sleeve takes place. Composite materials are often used here, for example a composite of a number of thin layers of paper, board, plastic or metal, in particular aluminium. Such packaging is widely used in the food industry in particular.

In the area of packaging technology numerous devices and methods are known, with which flat folded packaging sleeves can be unfolded, closed at one end, filled with contents and then completely sealed.

A particular challenge is the closing of the packaging sleeves, because the closing must achieve a reliable seal of the packaging sleeves, which must be able to withstand subsequent transport and other stresses. The closing often takes place in two steps: first, the packaging sleeve is heated in the area to be closed (“activated”). Then, the opposing sides of the packaging sleeve are pressed together in the area to be closed (“compressed”). The cohesion between the compressed areas is for example achieved in that an internal layer of plastic is provided, which becomes viscous upon heating and thus in the subsequent compression forms a bond. This process is also referred to as “sealing”.

Such a device for sealing packaging sleeves is known from WO 00/44619 Al. With this device the packaging sleeves to be closed are carried in cassettes which are secured to a conveyor belt. The cassettes are designed in such a way that the upper and lower sides of the areas of the packaging sleeve to be closed protrude from the cassettes. The lower sides of the packaging sleeve are first guided through a forming station with two rails arranged opposite one another, by means of which the lower sides of the packaging sleeve are pushed together. Then the lower sides of the packaging sleeve are passed through a sealing device, in which the packaging sleeve is inductively heated. Next, the lower sides of the packaging sleeves are first passed through a pressing device and then a support device. Both the pressing device and the support device comprise rollers arranged opposite one another, between which the lower sides of the packaging sleeve are pressed together.

The device known from WO 00/44619 Al has the advantage that during the processing steps described, the packaging sleeves can be continually moved on, allowing uninterrupted processing. A disadvantage, however, has proved to be the pressing together by stationary rollers. A disadvantage of rollers is that the rollers cannot be pressed simultaneously along the entire length of the packaging sleeve, but roll away from the packaging sleeve at different times, resulting in an uneven distribution of the viscous plastic. A further disadvantage is that stationary rollers, despite the use of rubber, are only able to respond inadequately to changes in the material thickness of the packaging sleeve. Such changes can occur, for example, as the packaging sleeve enters or exits the rollers, or in the area of material overlaps or fold lines. At high transport speeds in particular, the rollers “jump” at such steps. This can result in an uneven contact pressure and possibly an unreliable seal.

Alternative devices for sealing packaging sleeves are known from EP 0 615 909 Al and WO 98/43876 Al. With these devices pressing elements are provided which can be moved linearly one after another such that the packaging sleeves are pressed together in the area to be closed. The pressing elements can be displaced during the pressing process in high-frequency oscillations, as a result of which the packaging sleeve is heated and sealed (“ultrasonic welding”). An advantage of these devices is that the steps of “heating” and “pressing together” are combined and performed simultaneously by the same tool. In addition, the entire weld seam can be created simultaneously and thus particularly evenly.

A disadvantage, however, is the fact that with the device from EP 0 615 909 Al and from WO 98/43876 Al no continuous, uninterrupted conveyance of the packaging sleeves is possible. Instead, the packaging sleeves must be halted so that they can be sealed by the tool. Only then can the conveyance of the packaging sleeve be continued. So this is an intermittent mode of operation. The reason for this restriction is that a design allowing the sealing tools oscillating at high-frequency to move in stages with the packaging sleeves, as they are conveyed, and then be returned, would be very complicated. An intermittent mode of operation has the disadvantage that the device, together with the packaging and content, is subject to high mechanical stresses due to the constant accelerations. This can result in high levels of wear of the device and slopping or foaming of the packaging contents. In addition, the production performance of intermittent systems is often lower than the production performance of continuously operating systems.

The problem for the invention is therefore to develop and further improve a device described and explained in more detail above, so that the reliable compression of packaging sleeves can also be achieved with the continuous conveyance of the packaging sleeves.

This problem is solved by a device according to the preamble of claim 1, in that the pressure bars are supported in such a way that the pressure bars are movable in the longitudinal direction of the gap.

A device according to the invention for compressing—that is, pressing together—packaging sleeves is characterised firstly by two movably supported pressure bars for compressing the packaging sleeve. The pressure bars preferably have an elongated shape, such that their extension in the longitudinal direction is greater than their extension in the transversal and/or vertical direction. Furthermore, the extension of the pressure bars in the longitudinal direction is preferably greater than the length of the areas to be compressed of the packaging sleeves, so that the entire weld seam can be encompassed by the pressure bars in a single step. The pressure bars are preferably made from metal, in particular steel due to its high rigidity. The device is also characterised by at least one drive for moving the pressure bars. The drive preferably comprises a motor, for example an electric motor, and—where necessary—power transmission elements such as toothed belts, shafts, articulations, adapters and so on. Provision can be made for each pressure bar to be driven by one or more separate drives. The pressure bars of the device are supported in such a way that between the pressure bars a gap is created, the longitudinal direction of which corresponds to the transport direction of the packaging sleeve. This arrangement of the pressure bars and alignment of the gap allows the packaging sleeve with its area to be compressed to be guided through the gap, without having to be stopped or redirected for compression. The pressure bars of the device are also supported in such a way that the distance between the pressure bars is adjustable. A change to this distance can mean both a reduction and an increase in the distance. By changing the distance, the pressure bars can adopt an “open” and a “closed” position, so that the packaging sleeves are held tight by the pressure bars during compression and released again after compression. The change in distance can in particular be effected by the movement of at least one of the pressure bars in the transversal direction of the gap. Four or more movably supported pressure bars for compressing the packaging sleeve can also be provided, of which preferably at least two pressure bars are arranged on one side of the gap and at least two pressure bars on the other side of the gap. The pressure bars can for example be arranged on top of each other. With this configuration a plurality of drives is preferably provided on both sides of the gap, so that the pressure bars can be moved independently of one another, for example in the opposite direction or alternately. In other words, in a configuration with four pressure bars, two opposing pressure bars are in the open position, while the other two opposing pressure bars are in the closed position.

According to the invention it is proposed that the pressure bars are supported in such a way that the pressure bars are movable in the longitudinal direction of the gap. The intention, therefore, is that the pressure bars can be moved not only in the transversal direction of the gap, but also in the longitudinal direction of the gap—and thus in the transport direction of the packaging sleeve.

Preferably, the movements in the transversal direction of the gap and in the longitudinal direction of the gap are superimposed and therefore take place simultaneously. A movement “in the longitudinal direction” (thus in the transport direction) of the gap means, in the context of this invention, also a movement in the opposite direction (thus against the transport direction). The same applies to movements “in the transversal direction”. A movement of the pressure bars in the longitudinal direction of the gap does not necessarily mean a movement that takes place exclusively in the longitudinal direction of the gap; instead, a complex movement may be involved, also having a component in the longitudinal direction of the gap. In a corresponding manner, a movement of the pressure bars in the transversal direction of the gap does not necessarily mean a movement that takes place exclusively in the transversal direction of the gap; instead, a complex movement may be involved, also having a component in the transversal direction of the gap. For example, the movement of the pressure bars may be a movement along a circular path, an oval, or another closed curve, since such movements contain components of movement both in the transversal direction and components of movement in the longitudinal direction. A movement of the pressure bars in the longitudinal direction of the gap allows the pressure bars during the pressing process to be conveyed with the moving packaging sleeves. This has the considerable advantage that the packaging sleeve does not have to be stopped for the compression. Instead, a continuous, uninterrupted conveyance of the packaging sleeve is possible. The invention is thus based on the idea of combining a pressing movement (component of movement in the transversal direction of the gap) with a conveying movement (component of movement in the longitudinal direction of the gap).

One configuration of the device provides that the pressure bars are supported in such a way that pressure bars are movable along a closed curve, in particular along a circular path. A movement along a closed curve, for example along a circular path, is composed of alternating increasing and decreasing movement parts in the longitudinal direction and movement parts in the transversal direction and is therefore particularly suited to a pressing movement (movement component in the transversal direction of the gap) with a conveying movement (movement component in the longitudinal direction of the gap). In constructional terms, a movement along a circular path is also easy to achieve by driving each pressure bar with two rotating components with an identical direction of rotation and an identical speed of rotation. In this case the pressure bar is supported and guided like a coupling rod on a railway vehicle, in particular a traction unit, with multiple wheelsets coupled together, in order to transmit the driving force to all axles. In other words, the intention is for the pressure bars not to rotate about their body axes, but overall to be displaced along a circular path or along another closed curve. A further advantage of the guidance along a circular path is that such movements can be easily balanced by counterweights, so that very high operating speeds are also possible. The guidance of the pressure bars along a non-circular closed curve, on the other hand, has the advantage that the movement of the pressure bars in the transversal direction of the gap (pressure bars “open” and “closed”) and the movement of the pressure bars in the longitudinal direction of the gap (conveyance of the pressure bars with the packaging sleeves during the pressing process) can be adjusted independently of one another. It is thereby preferably provided that a movement cycle of the pressure bars corresponds to a complete circulation of the circular path or the other closed curve. In turn, this can preferably correspond to a specific continuous speed of rotation of a drive. In order to vary the number of cycles performed, it can be provided that integer multiples of a cycle are reproduced on a closed curve.

A further proposal for this configuration is that the closed curve, in particular the circular path, lies in a single plane, determined by the longitudinal direction of the gap and by a transversal direction of the gap running vertically to this. The restriction to movability in a plane spanning two directions (longitudinal direction, transversal direction) represents a constructional simplification, since movability in the third direction (vertical direction) can be dispensed with. This makes supporting the pressure bars easier and at the same time allows a combination of the two functions sought of “compressing the packaging sleeve” (movement in the transversal direction of the gap) and “conveyance of the packaging sleeve” (movement in the longitudinal direction of the gap).

In a further embodiment of the device it is proposed that the pressure bars are supported by a common baseplate. The supporting by a common baseplate contributes to the rigidity and compactness of the device, for when supported by a common baseplate the opposing forces of the facing pressure bars are balanced out. This is because the forces introduced into the baseplate when the device is correctly adjusted always have the same magnitude and an opposite direction.

With regard to the pressure bars, in a further embodiment of the device, it is proposed that at least one pressure bar has a flexible bar. The flexible bar is preferably arranged on the side of the pressure bar which during the pressing process is in contact with the packaging sleeve. By means of the flexible bar, irregularities and changes in the material thickness of the packaging sleeve can be compensated, so that an even pressure distribution is achieved. The flexible bar is preferably made from synthetic material, in particular rubber. The flexible bar can, for example, be made from silicon with preference for a Shore A hardness in the range 55 to 70. Alternatively, the flexible bar can be made from EPDM (Ethylene-Propylene-Diene-Monomer), with preference for a Shore A hardness in the range 65 to 75. Furthermore, other elastic materials such as PU or PUR (polyurethane) with a Shore A hardness of 40 to 95 can be used. Good results have been achieved with flexible bars, which arch outwards, thus having a convex shape. The flexible bar preferably has a thickness in the range between 2 mm and 10 mm, preferably between 3 mm and 7 mm.

The device can be advantageously further improved by at least four pivoted shafts. The shafts can for example serve to create a mechanical connection between the drive and the pressure bars and thus transmit the drive power to the pressure bars. Each pressure bar is preferably connected with two shafts and is driven by both shafts. For a device with two pressure bars, therefore, four shafts are preferable. Due to the rotation of the shafts, the shafts are particularly suited to generating a circular movement of the pressure bars. The pivoting of the shafts can in particular be achieved by rolling bearings, wherein each shaft is preferably supported by two rolling bearings.

For this further improvement it is further proposed that the shafts are supported by a common baseplate. Because all shafts are supported in the same baseplate, the compactness of the device is increased. In addition, the driving of the shafts is facilitated because the drive motor can also be supported on the baseplate. A further advantage of support in a common baseplate is that a sufficiently rigid baseplate ensures that the desired distances between the axes of rotation of the shafts remains constant even under load and can be maintained with great accuracy.

A further configuration of the device provides that the shafts have axes of rotation arranged in parallel to one another. Through a parallel arrangement of the axes of rotation, the driving of the shafts by a common belt is facilitated, since the belt does not have to compensate for any angular differences. The axes of rotation of the shafts are preferably arranged parallel to the vertical direction of the gap.

According to a further embodiment of the device, the supporting of the shafts can be enhanced by inserts for supporting the shafts in the baseplate. The inserts preferably have a length that is greater than the thickness of the baseplate. In this way the shafts can be supported with a particularly large span, thereby increasing the rigidity of the support. Alternatively, or additionally to this the inserts can be made from a material that allows a sliding support to be created between the shafts and the inserts. In this case rolling bearings can be dispensed with. Suitable materials have proven to be synthetic materials as well as bronze and brass alloys.

According to a further configuration the device can be added to by an eccentric element, connected to the shaft so that it cannot rotate. An eccentric element is understood to be a component, the mid-point or central axis of which lies outside the axis of rotation. The eccentric element is preferably designed such that its central axis runs parallel to the axis of rotation of the shaft, to which the eccentric element is connected. Because of the connection between the eccentric element and shaft, the axis of rotation of the eccentric element coincides with the axis of rotation of the shaft. The eccentric element facilitates an eccentric linkage of the pressure bar. In particular, the eccentric element means that the shaft itself does not have to have any eccentric areas but can have a continuous, rotationally symmetrical form. The eccentric element is preferably joined by a press fit with the shaft, so that rotational movements between both components can be reliably transmitted. In order to reliably prevent contamination of the packaging sleeve and/or its contents, in the area surrounding the eccentric element the device can for example be sealed by bellows that surround the shaft.

For this configuration it is further proposed that the eccentric element has an eccentricity in the range 0.5 mm to 5 mm. Eccentricity denotes the distance between the mid-point or the central axis and the axis of rotation of the eccentric element, wherein the axis of rotation of the eccentric element coincides with the axis of rotation of the shaft. An eccentricity in the stated range has proven to be the perfect compromise between sufficiently great lift and lowest possible imbalance as well as a compact design.

In a further embodiment of the device it is proposed to provide an adapter, supported rotatably on the eccentric element. A further rotatable support means that the pressure bars secured to the adapter do not have to assume the rotational movement of the eccentric element but can perform a movement independent of this. This movement can for example be a movement in which the pressure bars are indeed guided along a circular path but do not rotate around their own axis. A further advantage of an adapter is that different shaped, exchangeable pressure bars can be mounted on the adapter and used. The support between adapter and eccentric element can also be in the form of rolling bearings, in particular two rolling bearings or a sliding bearing.

According to a further configuration of the device it is provided that each pressure bar is secured on least two eccentric elements and/or at least two adapters. By guiding the pressure bars using two eccentric elements and/or adapters, guidance of the pressure bars along a circular path can in particular be achieved (comparable with a coupling rod on a railway engine). In addition, through multiple supports for the pressure bars higher compressive forces can be transmitted to the packaging sleeve.

An alternative embodiment of the device provides that the pressure bars are supported by at least two pivoted cranks. Support using two cranks allows a defined movement of the pressure bars to be achieved in a constructionally simple manner. Preferably all cranks, or in any case the cranks of the same pressure bar, are of identical length. The cranks are preferably made from metal, in particular steel or aluminium.

For this embodiment it is further proposed that each crank has a rotary drive. Through their own, preferably integral drive the cranks can be directly driven so that transmission means such as belts or toothed wheels can be dispensed with. The rotary drive can be provided in or on one of the ends of the crank, wherein the end turned away from the pressure bar is preferred. The rotary drive can for example be an electric motor.

In a further embodiment of the device it is proposed that the cranks are each connected rotatably with a push rod. Through the combination of a crank and a push rod a “crank mechanism” is created through which the more complex movements of the pressure bars can be achieved. For example, the rotational movement of the crank can have a translation movement of the push rod superimposed on it. Preferably all push rods, or in any case the push rods of the same pressure bar, are of identical length. The push rods are preferably made from metal, in particular steel or aluminium.

For this configuration it is further proposed that the push rods are guided on a linear track in the transversal direction of the gap. A linear track is a structurally simple and reliable solution for achieving a linear and thus straight movement of the push rods. Because the linear tracks extend in the transversal direction of the gap, the push rods are similarly movably supported in this direction so the movement of the push rods can in particular be used for “opening” and “closing” the pressure bars.

According to a further embodiment of the device it is proposed that at least one crank is rotatably connected with a further crank, rotatably connected with a push rod. Activation of one crank by another crank has the advantage that this crank does not need to have its own (rotary) drive. Instead, it is moved at the same time as, and by, the other crank.

For this embodiment it is further proposed that the push rods are guided on a linear track in the longitudinal direction of the gap. Through the alignment of the push rods in the longitudinal direction of the gap, the movement of these push rods can in particular be used to “convey” the pressure bars with the packaging sleeves transported. The combination of push rods running in the transversal direction of the gap and push rods running in the longitudinal direction of the gap has the advantage that the cranks connected with these push rods can be coupled together. The result of this is that a movement can be achieved with the cranks resulting from the superimposition of a longitudinal movement and a transversal movement.

According to a further teaching in terms of the device, it is provided that each push rod has a drive. By having their own drive, the push rods can be directly driven so that transmission means such as belts or toothed wheels can be dispensed with. The drive can be provided in or on the end of the push rod, wherein the end turned away from the pressure bar or crank is preferred. The drive can for example be an electric motor. For controlling the movement of the pressure bars a cam disc connected with the drive can for example be provided. In this way periodic switching of the pressure bars between their closed position (“pressing position”) and their open position can be achieved with shorter movement phases and longer rest phases (in the open and/or closed position) with high repeat accuracy. With a corresponding design of the cam disc, the push rods and the pressure bars can be moved in such a way that the rest phase occurring in the closed position lasts longer than the other phases put together.

Finally, the device can have a conveyor belt added with cells for receiving the packaging sleeves. By means of a conveyor belt or a transport belt, high tractive forces can be transmitted allowing a plurality of packaging sleeves to be transported at constant intervals one after another. The cells serve to accommodate the packaging sleeves. The packaging sleeves can be held in the cells by either a positive or a negative connection. The device can also have an aseptic chamber added, allowing the compression of the packaging sleeve in a sterile environment. In this way the device can also be used for the sterile filling of foodstuffs. An aseptic chamber is understood to be an area suitable for protecting a certain volume, in particular aseptic air, from an external environment, in particular non-aseptic air.

The abovementioned problem is also solved by a method for compressing packaging sleeves, comprising the following steps: a) providing a device for compressing packaging sleeves with at least two movably supported pressure bars for compressing the packaging sleeve and with at least one drive for moving the pressure bars; b) varying the distance between the pressure bars; and c) moving the pressure bars in the longitudinal direction of the gap.

As already described in connection with the device, the method is also based on the idea of combining a pressing movement (step b) with a conveying movement (step c). This has the considerable advantage that the packaging sleeve does not have to be stopped for the compression. Instead, a continuous, uninterrupted conveyance of the packaging sleeve is possible.

A configuration of the method provides that in step a) a device according to one of claims 1 to 21 is provided. The device described above is particularly suitable in all the configurations described for performing the method since with this device the pressure bars are able to both vary the distance from one another (“pressing movement”) and be moved in the longitudinal direction of the gap (“conveying movement”).

A further configuration of the method provides that the device has a conveyor belt with cells for accommodating the packaging sleeves and that the conveyor belt with the cells is moved continuously. Alternatively, it can be provided that the device has a transport belt with cells for accommodating the packaging sleeves and that the transport belt with the cells is moved intermittently. Continuous movement allows a particularly even and low-wear operation of the system and the processing of large quantities. Intermittent operation, on the other hand, has the advantage that multiple production or processing steps can be performed more simple on the packaging sleeves.

In a further embodiment of the method, steps b) and c) are performed simultaneously. Steps b) and c) can be performed simultaneously in phases or also continuously. Simultaneously performing the “pressing movement” and “conveying movement” has the advantage that particularly high operating speeds can be achieved since the packaging sleeve does not have to be stopped for compression. Instead, a continuous, uninterrupted conveyance of the packaging sleeve is possible.

According to a further configuration of the method, it is provided that steps b) and c) are carried out by the pressure bars being moved along a closed curve, in particular along a circular path. Guidance of the pressure bars along a closed curve, for example along a circular path, is a constructionally very easy way of combining a “pressing movement” (movement components in the transversal direction of the gap) with a “conveying movement” (movement components in the longitudinal direction of the gap).

For this configuration it is finally proposed that the maximum path velocity of the pressure bars in the transport direction is 1% to 5% higher than the transport speed of the packaging sleeve. The maximum path velocity for circular movements corresponds to the tangential speed at the radially outermost point. For the pressure bars this is the point or the surface that it is intended will come into contact with the packaging sleeves, thus the pressing surface. The intention is for this pressing surface to move somewhat faster than the packaging sleeve, since the pressure bars—in particular if flexible rubber strips or similar are provided thereon—have a certain elasticity and are thus slightly compressed during the pressing process. As a result of the compression, the distance between the pressing surface and the axis of rotation falls, so that the path velocity drops slightly. Against this background it has proven advantageous to move the pressure bars at a slightly excess speed.

The invention is further explained in the following using a drawing showing just one preferred embodiment. The drawing shows as follows:

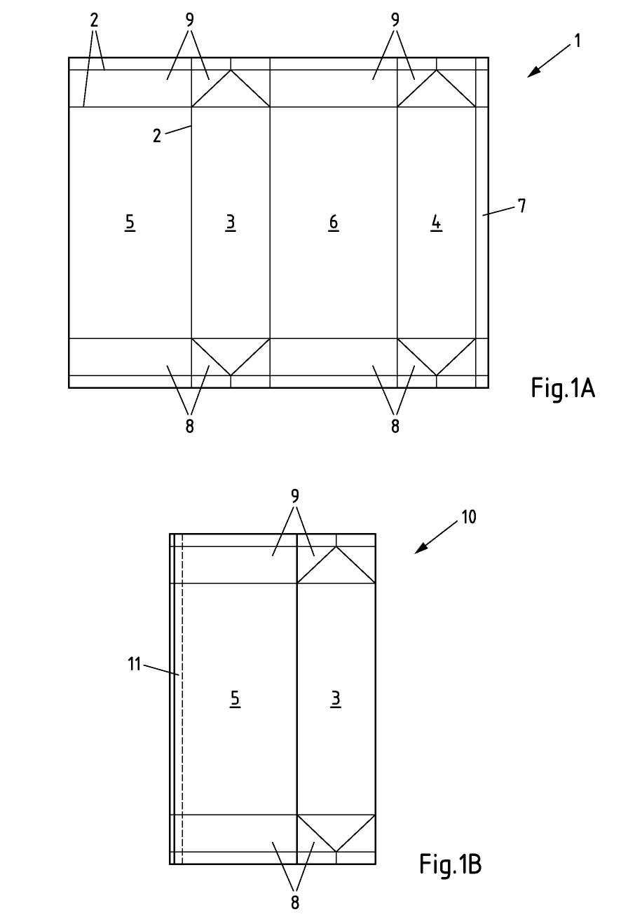

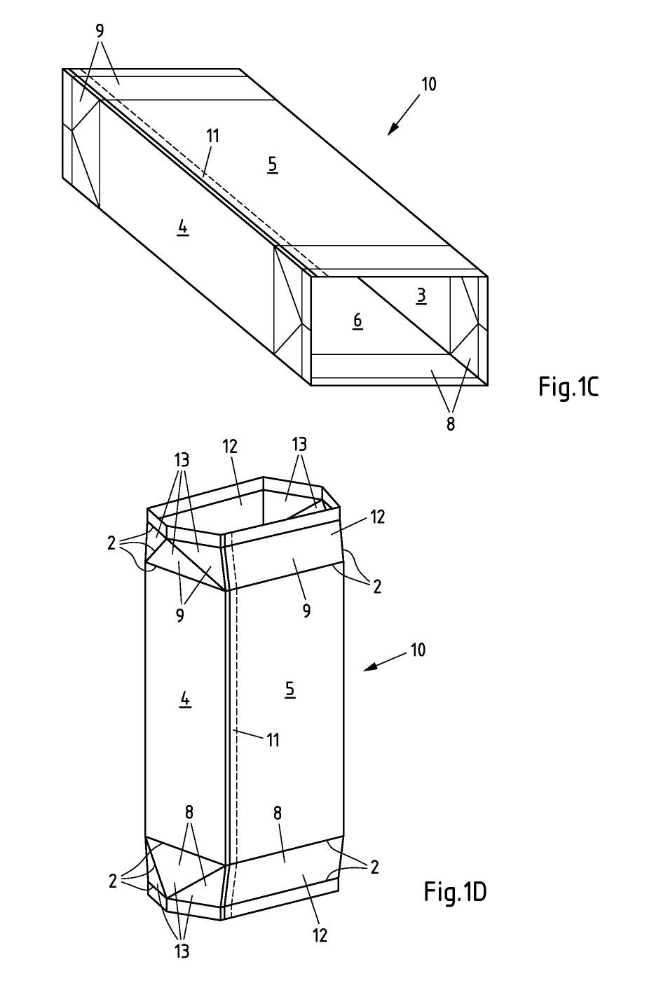

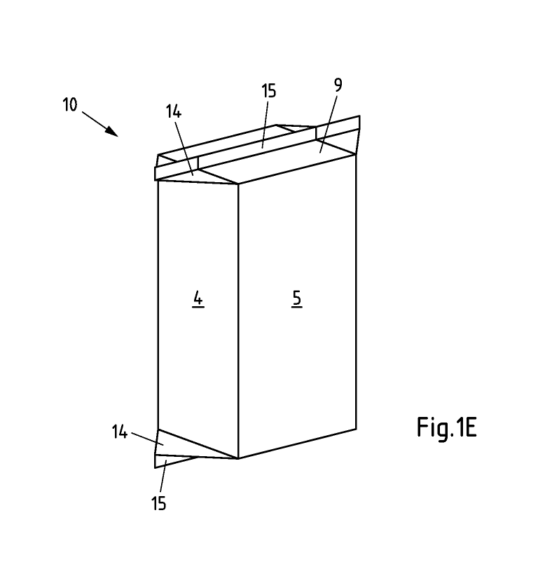

FIG. 1A a blank known from the prior art for folding a packaging sleeve;

FIG. 1B: a packaging sleeve known from the prior art formed from the blank shown in FIG. 1A, in the flat folded state;

FIG. 1C: the packaging sleeve from FIG. 1B in the unfolded state;

FIG. 1D: the packaging sleeve from FIG. 1C with pre-folded floor and gable surfaces;

FIG. 1E: the packaging sleeve from FIG. 1C following compression;

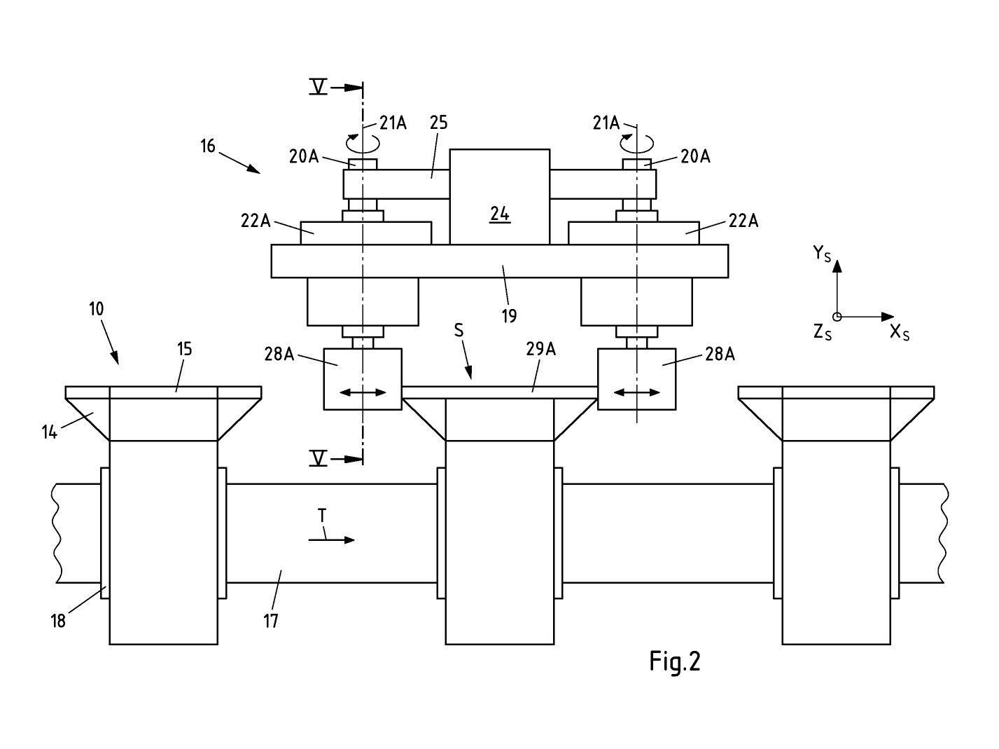

FIG. 2: a front view of first configuration of a device according to the invention for compressing packaging sleeves;

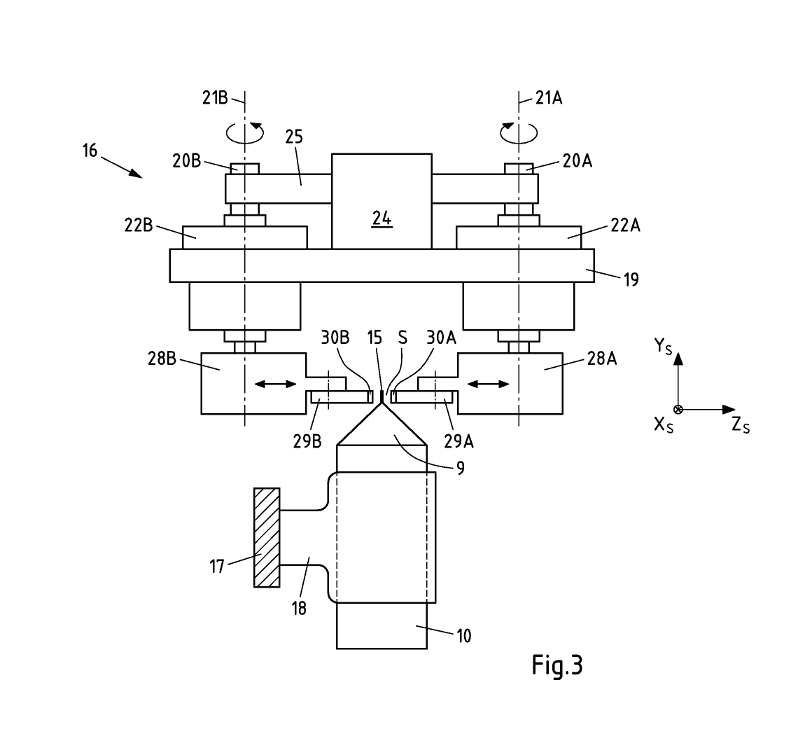

FIG. 3: a side view of the device for compressing packaging sleeves from FIG. 2;

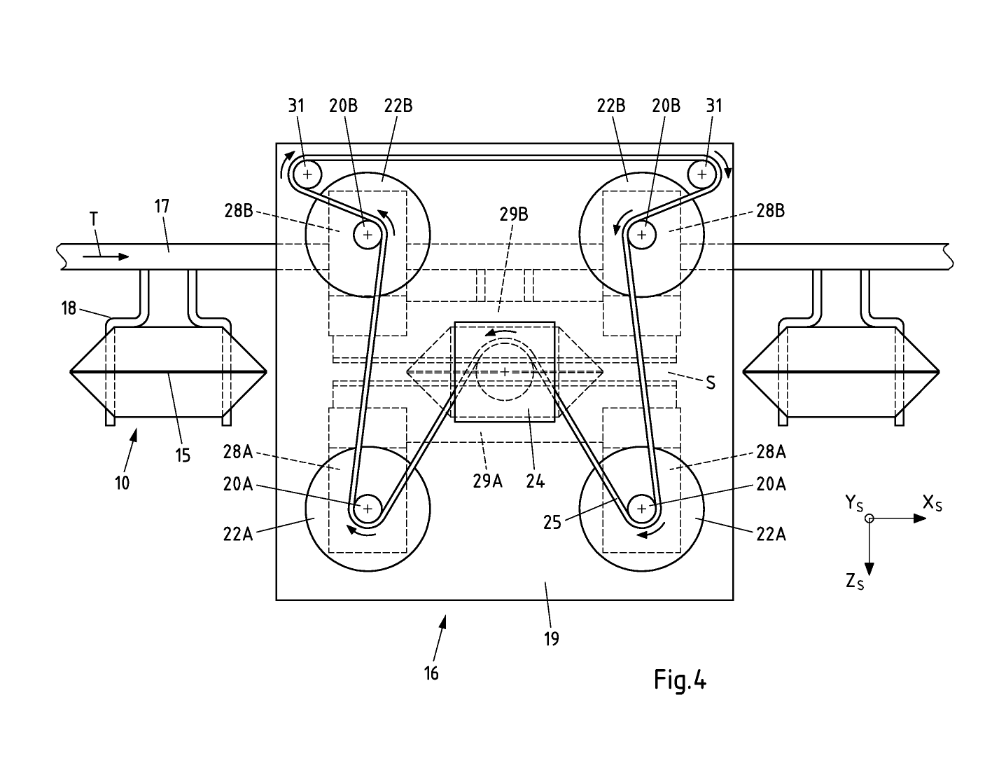

FIG. 4: a top view of the device for compressing packaging sleeves from FIG. 2;

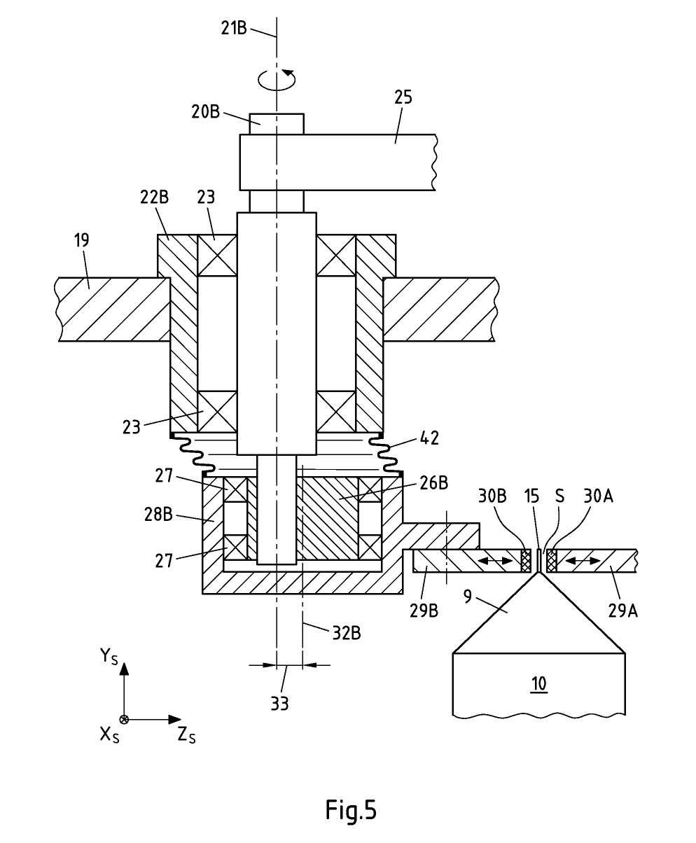

FIG. 5: a cross-sectional view along plane V-V from FIG. 2 of the device for compressing packaging sleeves from FIG. 2;

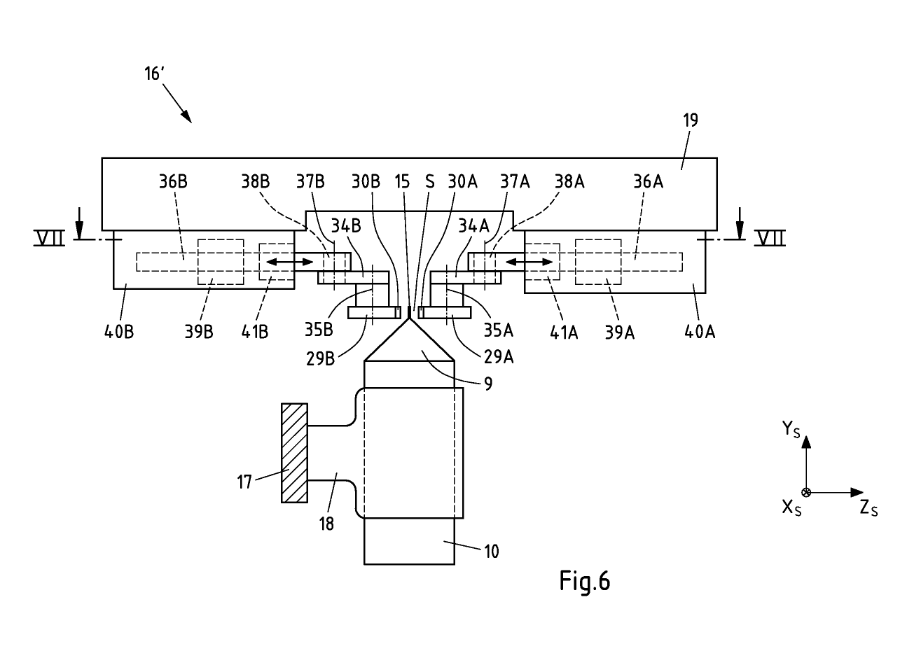

FIG. 6: a side view of a second configuration of a device according to the invention for compressing packaging sleeves;

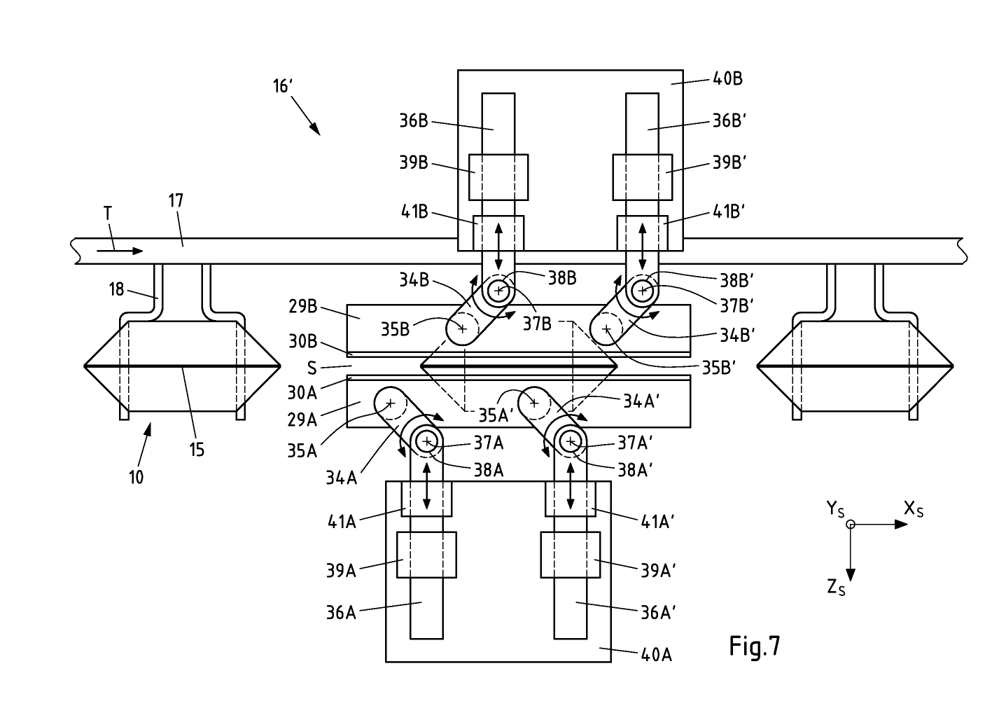

FIG. 7: a top view along plane VII-VII from FIG. 6 of the device for compressing packaging sleeves from FIG. 6;

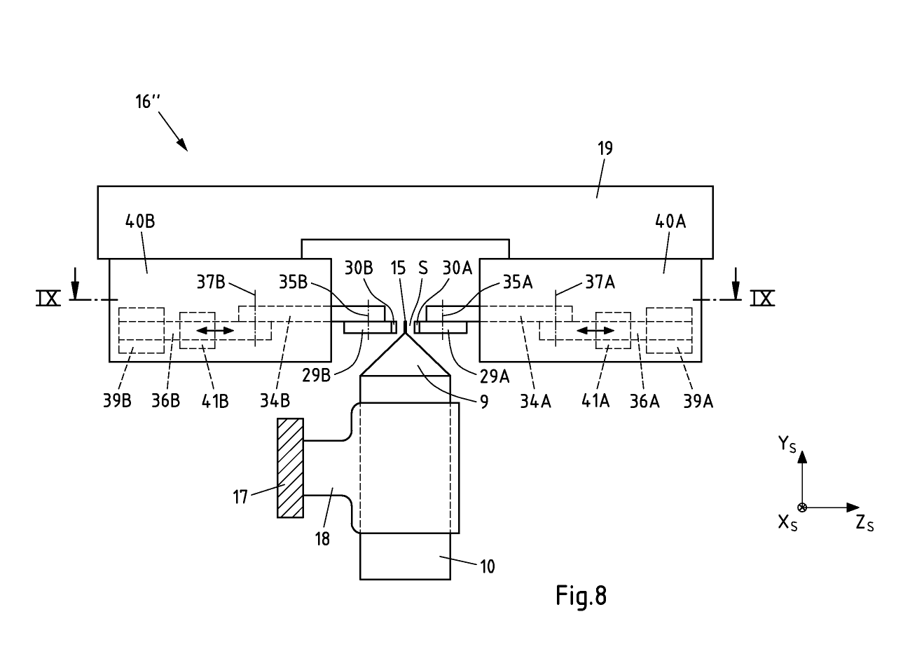

FIG. 8: a side view of a third configuration of a device according to the invention for compressing packaging sleeves; and

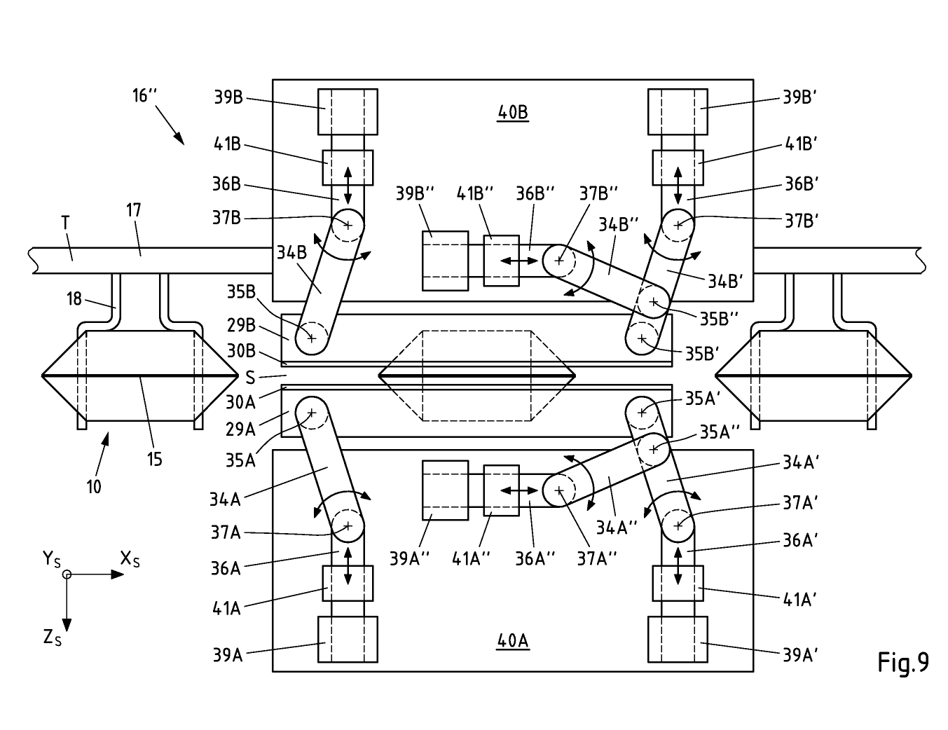

FIG. 9: a top view along the plane IX-IX from FIG. 8 of the device for compressing packaging sleeves from FIG. 8.

FIG. 1A shows a blank 1 known from the prior art, from which a packaging sleeve can be formed. Blank 1 can comprise multiple layers of different materials, such as paper, board, plastic or metal, in particular aluminium. Blank 1 has a number of fold lines 2, intended to facilitate the folding of blank 1 and divide the blank 1 into a number of surfaces. Blank 1 can be divided into a first side surface 3, a second side surface 4, a front surface 5, a rear surface 6, a sealing surface 7, floor surfaces 8 and gable surfaces 9. From blank 1 a packaging sleeve can be formed by blank 1 being folded in such a way that the sealing surface 7 can be bonded, in particular welded, with the front surface 5.

FIG. 1B shows a packaging sleeve 10 known from the prior art in the flat folded state. The areas of the packaging sleeve already described in relation to FIG. 1A are given corresponding references in FIG. 1B. The packaging sleeve 10 is formed from the blank 1 shown in FIG. 1A. For this, blank 1 has been folded in such a way that the sealing surface 7 and the front surface 5 are arranged in an overlapping manner so that the two surfaces can be extensively welded together. The result is a longitudinal weld seam 11. In FIG. 1B the packaging sleeve 10 is shown in a flat state, folded together. In this state one side surface 4 (concealed in FIG. 1B) is positioned below the front surface 5 while the other side surface 3 is lying on the rear surface 6 (concealed in FIG. 1B). In the folded, flat state a number of packaging sleeves 10 can be stacked in a particularly space-saving manner. Therefore, the packaging sleeves 10 are often stacked at the place of manufacture and transported in a stack to the place of filling. Only there are the packaging sleeves 10 de-stacked and unfolded in order to be able to be filled with contents, for example foodstuffs.

FIG. 1C shows the packaging sleeve 10 from FIG. 1B in the unfolded state. Here again, the areas of the packaging sleeve 10 already described in relation to FIG. 1A or FIG. 1B are given corresponding references. The unfolded state means a configuration in which between any two neighbouring surfaces 3, 4, 5 and 6 an angle of approximately 90° is formed, so that the packaging sleeve 10—depending on the form of these surfaces—has a square or rectangular section. Accordingly, the opposing side surfaces 3, 4 are arranged in parallel. The same applies to the front surface 5 and the rear surface 6.

FIG. 1D shows the packaging sleeve 10 from FIG. 1C in the pre-folded state, thus in a state in which the fold lines 2 both in the area of the floor surfaces 8 and in the area of the gable surfaces 9 have been pre-folded. Those areas of the floor surfaces 8 and the gable surfaces 9, bordering the front surface 5 and the rear surface 6, are also referred to as rectangular surfaces 12. During pre-folding, the rectangular surfaces 12 are folded inwards and subsequently form the floor or the gable of the packaging. Those areas of the floor surfaces 8 and the gable surfaces 9, bordering the side surfaces 3, 4, are on the other hand referred to as triangular surfaces 13. During pre-folding, the triangular surfaces 13 are folded outwards and form protruding areas of excess material, also referred to as “ears” 14 which in a subsequent manufacturing step—for example by a bonding process—are attached to the packaging.

FIG. 1E shows the packaging sleeve 10 from FIG. 1D after compression, thus in the filled and closed state. In the area of the floor surfaces 8 and in the area of the gable surfaces 9 after closing, a fin seam 15 results. In FIG. 1E the ears 14 and the fin seam 15 protrude. Both the ears 14 and the fin seam 15 are attached in a subsequent manufacturing step, for example by a bonding process.

FIG. 2 shows a front view of a first configuration of the device 16 according to the invention for compressing packaging sleeves. A transport belt 17 is also shown with cells 18, in which the packaging sleeves 10 are initially conveyed to the device 16 and after compression transported away again. The transport direction T of the packaging sleeves 10 therefore runs parallel to the transport belt 17. The device 16 comprises a baseplate 19, in which four shafts 20 are rotatably supported, only the front two shafts 20A of which can be seen in FIG. 2, behind which the two other shafts 20B are arranged. The structure of the device 16 in relation to FIG. 2 is explained solely in respect of the front two shafts 20A; the two rear shafts 20B have a corresponding structure, however. Each of the shafts 20A has an axis of rotation 21A. The axes of rotation 21A of the two shafts 20A are arranged parallel to one another. Each of the shafts 20A is rotatably supported in an insert 22A, that is pushed into a hole in the baseplate 19 and preferably attached to the baseplate 19 by a press fit so that it cannot rotate. Between the shafts 20A and the inserts 22A rolling bearings 23 (not shown in in FIG. 2) are provided, allowing rotation of the shafts 20A relative to the inserts 22A and thus also to the baseplate 19. The shafts 20A are driven together with the shafts 20B via an electric motor 24, driving the top ends of the four shafts 20 via a toothed belt 25. In order to achieve a positive connection and thus synchronous operation, at the top ends of the shafts 20 teeth are provided to match the toothed belt 25. Each shaft 20A is connected at its bottom end via a press fit with an eccentric element 26A (not shown in FIG. 2), which is rotatably connected via rolling bearings 27 (not shown in FIG. 2) with an adapter 28A.

A common pressure bar 29A is secured in each case to two adapters 28A and the intention is for it to compress the packaging sleeve 10 in the area of the fin seams 15. To this end, between the two pressure bars 29A and 29B (concealed in FIG. 2) arranged opposite one another a gap S is provided, through which the upper areas of the packaging sleeves 10 are guided. The gap S has a longitudinal direction Xs, corresponding to the transport direction T of the packaging sleeve 10. The gap S also has a vertical direction Ys and a transversal direction Zs, running perpendicularly to one another and vertically to the longitudinal direction Xs of the gap S (see system of coordinates in FIG. 2). The pressure bars 29A, 29B are supported in such a way that the distance between the pressure bars 29A, 29B is variable; a variation in this distance can in particular be achieved by moving one or both pressure bars 29A, 29B in the transversal direction Zs of the gap S. The pressure bars 29A, 29B are also supported in such a way that the pressure bars 29A, 29B are movable in the longitudinal direction Xs of the gap S and therefore during the pressing process can be conveyed with the moving packaging sleeves 10 (shown by double arrows in FIG. 2).

FIG. 3 shows a side view of the device 16 for compressing packaging sleeves from FIG. 2. For those areas of the device 16 already described in relation to FIG. 2, corresponding references are used in FIG. 3. Apart from one of the two front shafts 20A, in the side view one of the two rear shafts 20B can now be identified. The device 16 has two pressure bars 29A, 29B, which can be moved via two adapters 28A, 28B, respectively, and in so doing compress the packaging sleeve 10 in the area of its fin seams 15. To this end the distance between the two adapters 28A, 28B and the pressure bars 29A, 29B secured to it is varied (shown by double arrows in FIG. 3). In order to achieve the required movement, both front shafts 20A must rotate in the opposite direction to the two rear shafts 20B (shown by arrows in FIG. 3). Nevertheless, all four shafts 20 can be driven via the same toothed belt 25, wherein the necessary reversal of direction of rotation can be achieved for example by deflection rollers (not shown in FIG. 3), around which the toothed belt is 25 guided. At the ends directed towards the gap S of the pressure bars 29A, 29B, rubber strips 30A, 30B are provided, intended to compensate for irregularities in the packaging sleeve 10.

FIG. 4 shows a top view of the device 16 for compressing packaging sleeves from FIG. 2. For those areas of the device 16, already described in relation to FIG. 2 or FIG. 3, corresponding references are used in FIG. 4. In the top view, in particular the way in which the drive comprising the electric motor 24 and the toothed belt 25 operates can be identified. The electric motor 24 is arranged centrally on the baseplate 19 and drives the toothed belt 25 via a toothed wheel (direction of movement shown by arrows). The toothed belt 25 embraces all four shafts 20, and thus both the two front shafts 20A and the two rear shafts 20B. Alternatively to the solution shown and in this respect preferred, it can be provided that the toothed belt 25 embraces and drives just one of the front shafts 20A and one of the rear shafts 20B with the other shafts 20 being passively conveyed—for example by means of the pressure bars 29A, 29B. The way in which the device 16 works, however, requires the direction of rotation of the two front shafts 20A to be different from the direction of rotation of the two rear shafts 20B. The reversal of direction of rotation can be achieved for example by suitably arranged deflection rollers, which—exactly like the shafts 20—are rotatably supported on the baseplate 19 and similarly embraced by the toothed belt 25. The deflection rollers 31 are preferably supported so that they can be adjusted or swivelled in order for the tension of the toothed belt to also be set via the deflection rollers 31.

FIG. 4 is intended to show, by way of example, the way in which the drive works: in the path of the toothed belt 25 shown, rotation of the toothed wheel of the electric motor 24 anticlockwise (all directions of rotation are shown by arrows in FIG. 4) leads to both front shafts 20A rotating anticlockwise about their axes of rotation. This movement is transmitted via the two front adapters 28A to the front press plate 29A, which thus performs a clockwise circular movement. The two rear shafts 20B, however, rotate anticlockwise about their axes of rotation. This movement is transmitted via the two rear adapters 28B to the rear press plate 29B, which thus performs a clockwise circular movement. Through the opposing circular movements of the two press plates 29A, 29B, both a pressing movement (movement component in the transversal direction Zs) and a conveying movement (movement component in the longitudinal direction Xs) are achieved and combined.

FIG. 5 shows a cross-sectional view along the plane V-V from FIG. 2 of the device 16 for compressing packaging sleeves from FIG. 2. In FIG. 5 also, for those areas of the device 16 already described in relation to FIG. 2 to FIG. 4 corresponding references are used. From the cross-sectional view it can be clearly identified that the insert 22B is a cylindrical component with a hollow interior, which is pushed into a hole provided in the baseplate 19 and preferably connected with the baseplate 19 by a press fit so that it cannot rotate. In the insert 22B the shaft 20B is rotatably supported by two rolling bearings 23. The shaft 20B thus pierces the baseplate 19. In its bottom area the shaft 20B is connected with the eccentric element 26B so that it cannot rotate. The eccentric element 26B has a central axis 32B, running parallel to the axis of rotation 21B and which due to the eccentricity of the eccentric element 26B in each turning position is alongside the axis of rotation 21B. Between the central axis 32B of the eccentric element 26B and the axis of rotation 21B of the shaft 20B an offset 33 develops, also referred to as “eccentricity”. The double offset 33 corresponds to the travel of the adapter 28B and the press plate 29B secured to this in the transversal direction Zs (shown as a double arrow in FIG. 5) and in the longitudinal direction Xs (not shown in FIG. 5). The amount of eccentricity 33 remains constant during operation, but the direction changes, since the central axis 32B of the eccentric element 26B rotates about the stationary axis of rotation 21B of the shaft 20B. In order to compensate for the imbalance caused by the eccentric element 26B, the shaft 20B can be provided with a counterweight (not shown in FIG. 5). FIG. 5 illustrates the structure of the device 16 and the way it works with, for the sake of clarity, only one of the two rear shafts 20B; for the other rear shaft 20B and for the two front shafts 20A, however, the same applies by analogy. In order to reliably prevent contamination of the packaging sleeve 10 and/or its contents, in the area surrounding the eccentric element 26B the device 16 can for example be sealed by bellows 42 that surround the shaft. The bellows 42 can for example be arranged between the insert 22B and the adapter 28B and thus reliably protect the rolling bearings 23, 27—which may contain lubricant.

FIG. 6 shows a side view of a second configuration of a device 16′ according to the invention for compressing packaging sleeves. For those areas of the device 16′ already described in connection with the first configuration (FIG. 2 to FIG. 5), corresponding references are used in FIG. 6. The second configuration of the device 16′ differs from the configuration of the device 16 in particular by a different support and a different drive for the pressure bars 29A, 29B. Each of the two pressure bars 29A, 29B is rotatably supported on two cranks 34A, 34A′, and 34B, 34B′, respectively, of which in FIG. 6 only the two front cranks 34A, 34B can be identified. Axes of rotation 35A, 35A′, 35B, 35B′ run through the connecting plane between the pressure bars 29A, 29B and the cranks 34A, 34A′, 34B, 34B′. Each crank 34A, 34A′; 34B, 34B′ is for its part rotatably supported on a push rod 36A, 36A′, 36B, 36B′, of which similarly in FIG. 6 only the two front push rods 36A, 36B can be identified. Axes of rotation 37A, 37A′, 37B, 37B′ similarly run through the connecting plane between the cranks 34A, 34A′, 34B, 34B′ and the push rods 36A, 36A′, 36B, 36B′. In addition, between each crank 34A, 34A′, 34B, 34B′ and the associated push rod 36A, 36A′, 36B, 36B′ a rotary drive 38A, 38A′, 38B, 38B′ is arranged, able to bring about a rotational movement of the cranks 34A, 34A′, 34B, 34B′. The push rods 36A, 36A′, 36B, 36B′, on the other hand, are pushed back and forth by drives 39A, 39A′, 39B, 39B′, arranged in a housing 40A, 40B (movements of the push rods 36A, 36A′, 36B, 36B′ are indicated in FIG. 6 by double arrows). Here a linear movement of the push rods 36A, 36A′, 36B, 36B′ is ensured by linear guides 41A, 41A′, 41B, 41B′, which are similarly arranged in the housings 40A, 40B. The two housings 40A, 40B can be supported on the baseplate 19 or in another manner—for example separately.

FIG. 7 shows a top view along the plane VII-VII from FIG. 6 of the device 16′ for compressing packaging sleeves from FIG. 6. For those areas of the device 16′ already described in relation to the first configuration (FIG. 2 to FIG. 5) or to FIG. 6, corresponding references are used in FIG. 7. The baseplate 19 cannot be identified through the sectional plane in FIG. 7 and attention is turned towards the support and the drive of the pressure bars 29A, 29B. From the top view it is clearly identifiable that the push rods 36A, 36A′, 36B, 36B′ run in the transversal direction Zs of the gap S. Since the linear guides 41A, 41A′, 41B, 41B′ similarly run in the transversal direction Zs of the gap S, the push rods 36A, 36A′, 36B, 36B′ guided in these can likewise only be moved back and forth in the transversal direction Zs of the gap S (movements of the push rods 36A, 36A′, 36B, 36B′ indicated in FIG. 7 by double arrows). The cranks 34A, 34A′, 34B, 34B′, on the other hand, are rotatably connected with the push rods 36A, 36A′, 36B, 36B′ and can therefore be rotated about the axes of rotation 37A, 37A′, 37B, 37B′ (movements of the cranks 34A, 34A′, 34B, 34B′ likewise indicated in FIG. 7 by double arrows). Whereas the push rods 36A, 36A′, 36B, 36B′ are thus supported in such a way that they can perform a translational movement, the cranks 34A, 34A′, 34B, 34B′ are supported in such a way that they can perform a rotational movement. The resulting movement of the pressure bars 29A, 29B supported on the cranks 34A, 34A′, 34B, 34B′ is therefore a movement which results from the superimposition of a translational movement and a rotational movement.

FIG. 8 shows a side view of a third configuration of a device 16″ according to the invention for compressing packaging sleeves. For those areas of the device 16″ already described in relation to the first configuration (FIG. 2 to FIG. 5) or the second configuration (FIG. 6, 7), corresponding references are used in FIG. 8. The third configuration of device 16″ can also be distinguished from the first two configurations in particular by a different support and a different drive of the pressure bars 29A, 29B.

Each of the two pressure bars 29A, 29B can in turn be rotated on two cranks 34A, 34A′, 34B, 34B′, of which in FIG. 8 just the front two cranks 34A, 34B can be identified. Axes of rotation 35A, 35A′, 35B, 35B′ run through the connecting plane between the pressure bars 29A, 29B and the cranks 34A, 34A′, 34B, 34B′. Each crank 34A, 34A′, 34B, 34B′ is rotatably supported on a push rod 36A, 36A′, 36B, 36B′, of which in FIG. 8 again only the front two push rods 36A, 36B can be identified. Axes of rotation 37A, 37A′, 37B, 37B′ similarly run through the connecting plane between the cranks 34A, 34A′, 34B, 34B′ and the push rods 36A, 36A′, 36B, 36B′. Unlike the second configuration, however, no rotary drives are arranged between the cranks 34A, 34A′, 34B, 34B′ and the push rods 36A, 36A′, 36B, 36B′ connected to them. In the third configuration, the rotational movement of the cranks 34A, 34A′, 34B, 34B′ is brought about in another way—as described below. The push rods 36A, 36A′, 36B, 36B′ are in turn moved back and forth by drives 39A, 39A′, 39B, 39B′, arranged in a housing 40A, 40B (movements of the push rods 36A, 36A′, 36B, 36B′ shown in FIG. 8 by double arrows). A linear movement of the push rods 36A, 36A′, 36B, 36B′ is ensured here by linear guides 41A, 41A′, 41B, 41B′, also arranged in the housings 40A, 40B. Both housings 40A, 40B can be supported on the baseplate 19 or in another way—separately, for example.

Finally, FIG. 9 shows a top view of the device 16″ for compressing packaging sleeves from FIG. 8 along the plane IX-IX from FIG. 8. For those areas of the device 16″, already described in relation to the first configuration (FIG. 2 to FIG. 5), the second configuration (FIG. 6, 7) or FIG. 8, corresponding references are also used in FIG. 9. Due to the path of sectional plane IX-IX the baseplate 19 cannot be identified in FIG. 9 and attention is turned towards the support and the drive of the pressure bars 29A, 29B. In the top view it can clearly be identified that apart from the four push rods 36A, 36A′, 36B, 36B′ and four cranks 34A, 34A′, 34B, 34B′ already known from the second configuration, a further two push rods 36A″, 36B″ are provided, on each of which a further crank 34A″, 34B″ is rotatably supported. Axes of rotation 37A″, 37B″ run through the connecting plane between the cranks 34A″, 34B″ and the push rods 36A″, 36B″. The two additional cranks 34A″, 34B″ are not rotatably connected with the pressure bars 29A, 29B, however, but with two other cranks 34A′, 34B′. Axes of rotation 37A″, 37B″ run through the connecting points between cranks 34A′, 34B′ and cranks 34A″, 34B″.

The two additional push rods 36A″, 36B″ differ from the four other push rods 36A, 36A′, 36B, 36B′ by their alignment: whereas the four push rods 36A, 36A′, 36B, 36B′ run in the transversal direction Zs of the gap S, the two push rods 36A″, 36B″ run in the longitudinal direction Xs of the gap S, thus in the transport direction T. The four linear guides 41A, 41A′, 41B, 41B′ similarly run in the transversal direction Zs of the gap S; the two linear guides 41A″, 41B″, on the other hand, run in the longitudinal direction Xs of the gap S, thus in transport direction T. The result of this is that the push rods 36A, 36A′, 36B, 36B′ guided in the linear guides 41A, 41A′, 41B, 41B′ are moved back and forth only in the transversal direction Zs of the gap S, whereas the push rods 36A″, 36B″ guided in the linear guides 41A″, 41B″ are moved back and forth only in the longitudinal direction Xs of the gap S, thus in the transport direction T (movements of the push rods 36A, 36A′, 36A″, 36B, 36B′, 36B″ in FIG. 9 indicated by double arrows). All push rods 36A, 36A′, 36A″, 36B, 36B′, 36B″ are moved back and forth by drives 39A, 39A′, 39A″, 39B, 39B′, 39B″, arranged in the housings 40A, 40B.

All cranks 34A, 34A′, 34A″, 34B, 34B′, 34B″ are rotatably connected with the push rods 36A, 36A′, 36A″, 36B, 36B′, 36B″ and can therefore be rotated about the axes of rotation 37A, 37A′, 37A″, 37B, 37B′, 37B″ (movements of the cranks 34A, 34A′, 34A″, 34B, 34B′, 34B″ also indicated by double arrows in FIG. 9). Whereas push rods 36A, 36A′, 36A″, 36B, 36B′, 36B″ are thus supported in such a way that they can perform a translational movement, cranks 34A, 34A′, 34A″, 34B, 34B′, 34B″ are supported in such a way that they can perform a rotational movement. With the third configuration of the device 16″, the resulting movement of the pressure bars 29A, 29B supported on the cranks 34A, 34A′, 34B, 34B′ is therefore also a movement resulting from the superimposition of a translational movement and a rotational movement.

### LIST OF REFERENCE SYMBOLS

1: Blank
2: Fold line
3, 4: Side surface
5: Front surface
6: Rear surface
7: Sealing surface
8: Floor surface
9: Gabel surface
10: Packaging sleeve
11: Longitudinal weld seam
12: Rectangular surface
13: Triangular surface
14: Ear
15: Fin seam
16,16′, 16″: Device for compressing packaging sleeves
17: Transport belt
18: Cell
19: Baseplate
20, 20A, 20B: Shaft
21A, 21B: Axis of rotation (of shaft 20A, 20B)
22A, 22B: Insert
23: Rolling bearing
24: Electric motor
25: Toothed belt
26A, 26B: Eccentric element
27: Rolling bearing
28A, 28B: Adapter
29A, 29B: Pressure bar
30A, 30B: Rubber strip
31: Deflection roller
32A, 32B: Central axis (of the eccentric element 26A, 26B)
33: Eccentricity
34A, 34A′, 34A″, 34B, 34B′, 34B″: Crank
35A, 35A′, 35A″, 35B, 35B′, 35B″: Axis of rotation (crank/pressure bar)
36A, 36A′, 36A″, 36B, 36B′, 36B″: Push rod
37A, 37A′; 37A″, 37B, 37B′, 37B″: Axis of rotation (push rod/crank)
38A, 38A′, 38B, 38B′: Rotary drive
39A; 39A′; 39A″, 39B, 39B′, 39B″: Drive
40A, 40B: Housing
41A, 41A′, 41A″, 41B, 41B′, 41B″: Linear guide
42: Bellows
S: Gap
Xs: Longitudinal direction (of the gap S)
Ys: Vertical direction (of the gap S)
Zs: Transversal direction (of the gap S)
T: Transport direction of the packaging sleeve

1.-28. (canceled)

29. A device for compressing packaging sleeves, comprising:
at least two movably supported pressure bars for compressing the packaging sleeve, and
at least one drive for moving the pressure bars,
wherein the pressure bars are supported in such a way that between the pressure bars a gap is created, a longitudinal direction of which corresponds to a transport direction of the packaging sleeve,
wherein the extension of the pressure bars in the longitudinal direction of the gap is greater than their extension in a transversal or vertical direction,
wherein the pressure bars are supported in such a way that the distance between the pressure bars is variable, and
wherein the pressure bars are supported in such a way that the pressure bars are movable in the longitudinal direction of the gap,
wherein the pressure bars are supported in such a way that the pressure bars are movable along a non-circular closed curve.

30. The device according to claim 29, wherein the closed curve lies in a plane defined by the longitudinal direction of the gap and by the transversal direction of the gap running vertically thereto.

31. The device according to claim 29, wherein the pressure bars are supported on a common baseplate.

32. The device according to claim 29, wherein at least one of the pressure bars comprises a flexible bar.

33. The device according to claim 29, further comprising at least four rotatably supported shafts.

34. The device according to claim 33, wherein the rotatably supported shafts are supported in a common baseplate.

35. The device according to claim 33, wherein the rotatably supported shafts have axes of rotation arranged in parallel to one another.

36. The device according to claim 33, further comprising inserts for supporting the rotatably supported shafts in the baseplate.

37. The device according to claim 33, further comprising an eccentric element, connected to at least one of the rotatably supported shafts so that it cannot rotate.

38. The device according to claim 37, wherein the eccentric element has an eccentricity in the range between 0.5 mm and 5 mm.

39. The device according to claim 37, further comprising an adapter, supported rotatably on the eccentric element.

40. The device according to claim 37, wherein each pressure bar is secured on at least two eccentric elements and/or to at least two adapters.

41. The device according to claim 29, wherein the pressure bars are each supported on at least two rotatably supported cranks.

42. The device according to claim 41, wherein each crank has a rotary drive.

43. The device according to claim 41, wherein each of the cranks is rotatably connected with one of a plurality of push rod.

44. The device according to claim 43, wherein each of the push rods is guided in a linear guide in the transversal direction of the gap.

45. The device according to claim 41, wherein at least one of the cranks is rotatably connected with a secondary crank, the secondary crank is rotatably connected with a secondary push rod.

46. The device according to claim 45, wherein the secondary push rods are guided in a linear track in the longitudinal direction of the gap.

47. The device according to claim 43, wherein each push rod and secondary push rod has a drive.

48. The device according to claim 29, further comprising a transport belt with cells for receiving the packaging sleeves.

49. A method for compressing packaging sleeves comprising multiple layers of different material, the method comprising:
a) providing a device for compressing packaging sleeves with at least two movably supported pressure bars for compressing the packaging sleeve and with at least one drive for moving the pressure bars;
b) varying the distance between the pressure bars; and
c) moving the pressure bars in a longitudinal direction of a gap between the pressure bars,
wherein the steps b) and c) are performed by moving the pressure bars along a non-circular closed curve.

50. The method according to claim 49, wherein in step a) the device comprises a device according to claim 29.

51. The method according to claim 50, wherein the device has a transport belt with cells for receiving the packaging sleeves and wherein the transport belt with the cells is moved continuously.

52. The method according to claim 50, wherein the device has a transport belt with cells for receiving the packaging sleeves and wherein the transport belt with the cells is moved intermittently.

53. The method according to claim 49, wherein steps b) and c) are performed simultaneously.

54. The method according to claim 49, wherein the maximum path velocity of the pressure bars in a transport direction is 1% to 5% higher than a transport speed of the packaging sleeve.
